(19) United States
(12) Patent Application Publication
(10) Pub. No.: US 2014/0324400 A1
(43) Pub. Date: Oct. 30, 2014

(54) Gesture-Based Visualization System for Biomedical Imaging and Scientific Datasets

(71) Applicant: Marquette University, Milwaukee, WI (US)

(72) Inventors: David J. Quam, Milwaukee, WI (US); John F. LaDisa, JR., Wauwatosa, WI (US); Ronald K. Woods, Whitefish Bay, WI (US)

(73) Assignee: MARQUETTE UNIVERSITY, Milwaukee, WI (US)

(21) Appl. No.: 14/265,886

(22) Filed: Apr. 30, 2014

Related U.S. Application Data
(60) Provisional application No. 61/817,627, filed on Apr. 30, 2013.

(51) Int. Cl. G06F 19/00

(52) U.S. Cl. CPC G06F 19/3437
USPC 703/2; 703/11

(57) ABSTRACT

Three-dimensional visualization of biomedical datasets in an immersive visual environment includes creating a finite element mesh patient specific three-dimensional mode. Points from the finite element mesh are removed to produce a refined patient specific three-dimensional model. The three-dimensional model and simulation are interpolated onto a uniform rectilinear grid. The refined patient specific three-dimensional model and the simulation data are transformed to a scale of the IVE. The refined patient specific three-dimensional model and the simulation data are presented within the IVE with a three-dimensional visualization system.

### CROSS-REFERENCE TO RELATED APPLICATION

The present application claims priority of U.S. Provisional Patent Application No. 61/817,627, filed on Apr. 30, 2013, the contents of which is incorporated herein by reference in its entirety.

### BACKGROUND

Modern scientific research produces data at rates that far outpace an individual's ability to comprehend and analyze it. Such sources include medical imaging data and computer simulations, where technological advancements and spatiotemporal resolution generate increasing amounts of data from each scan or simulation. A bottleneck has developed whereby medical professionals and researchers are unable to fully use the advanced information available to them. New and useful techniques in visualization and gesture control as disclosed herein have produced results that are of clinical utility and overcome the data problem that has developed.

In order to process, comprehend, and make advancements from the massive amounts of produced data, new methods of analyzing are required. Techniques for visualization have been developed as an off shoot of computer science, and can be leveraged in the scientific and medical community to enable researchers to relieve the data analysis bottleneck that has developed in recent years. The process of data visualization is an iterative process whereby data from either computations or measurements are fed to the system and continuously transformed and rendered until the desired features are extracted. Visualization methods provide tools with which data is transferred and rendered. Such an iterative process for data visualization often requires continuous refinement of display parameters such as color mapping, opacity mapping, or adjusting the size of the field of view. This continuous refinement currently requires large expenditures in time in order to visualize data which can detract users from adopting visualization processes.

### BRIEF DISCLOSURE

An exemplary embodiment of an method of three-dimensional visualization of biomedical datasets in an immersive visualization environment (IVE) includes obtaining imaging data. A patient specific three-dimensional model is created from the imaging data. The patient specific three-dimensional model includes a finite element mesh. A simulation is performed on the patient specific three-dimensional model to obtain simulation data. Points from the finite element mesh are removed leaving only points on the surface of an imaged anatomical structure to produce a refined patient specific three-dimensional model. The refined patient specific three-dimensional model and the simulation data is interpolated onto a uniform rectilinear grid. The refined patient specific three-dimensional model and simulation data is transformed to a scale of the IVE. The refined patient specific three-dimensional model and the simulation data are presented within the IVE with a three-dimensional visualization system.

An additional exemplary embodiment of a method of three-dimensional visualization of biomedical datasets in an immersive visualization environment (IVE) includes obtaining imaging data. A patient specific three-dimensional model is created from the imaging data. The patient specific three-dimensional model is a finite element mesh. A simulation is performed on the patient specific three-dimensional model to obtain simulation data. Points from the finite element mesh are removed, leaving only points on the surface of an imaged anatomical structure to produce a refined patient specific three-dimensional model. The refined patient specific three-dimensional model and the simulation data are interpolated onto a uniform rectilinear grid. The refined patient specific three-dimensional model and the simulation data is transformed to a scale of the IVE. A direction of flow within the refined patient specific three-dimensional model is determined. The refined patient specific three-dimensional model is rotated such that the direction of flow is parallel to a floor of the IVE. A three-dimensional plane is created for each of a plurality of sorted medical images. Each of the three-dimensional planes is translated to the origin of the IVE based upon an imaging modality used to acquire the plurality of stored medical images and the anatomical structure image. Each of the three-dimensional planes is translated to the three-dimensional model to register the stored medical images to the three-dimensional model. The refined patient specific three-dimensional model, the simulation data, and the registered medical images are presented within the IVE with a three-dimensional visualization system.

An exemplary embodiment of a system for visualization of biomedical datasets in an immersive visualization environment (IVE) includes a computing system, a graphical display and a user input device. The computing system includes a processor and a computer readable medium program with computer readable code that upon execution by the processor obtains imaging data. The processor creates a patient specific three-dimensional model from the imaging data. The patient specific three-dimensional model is a finite element mesh. The processor performs a simulation on the patient specific three-dimensional model to obtain the simulation data. The processor removes points from the finite element mesh leaving only points on a surface of an image anatomical structure to produce a refined patient specific three-dimensional model. The processor interpolates the refined patient specific three-dimensional model and the simulation data onto a uniform rectilinear grid. The processor transforms the refined patient specific three-dimensional model and the simulation data to a scale of the IVE. The graphical display is operated by the computing system to create the IVE and present the refined patient specific three-dimensional model and the simulation data within the IVE. The user input device is capable of acquiring a user gesture input. The computing system identifies an acquired user gesture input and modifies the presented refined patient specific three-dimensional model and the simulation data within the IVE in accordance with the gesture input.

### BRIEF DESCRIPTION OF THE DRAWINGS

FIG. 1 is a flow chart that depicts an exemplary embodiment of a method for visualizing medical imaging and simulation results.

FIG. 2 depicts an exemplary embodiment of medical images registered to a 3D model of a vessel.

FIG. 3 depicts an additional exemplary embodiment of medical images registered to a 3D model of a vessel.

FIGS. 4A-C depict an exemplary embodiment of the visualization of blood flow simulation data in a patient specific model.

FIG. 5 is a flow chart that depicts an exemplary embodiment of a method of post processing image data for rapidly visualizing medical imaging and simulation results.

FIG. 6A depicts an anatomical structure of a heart depicting a slicing vector.

FIG. 6B is an exemplary embodiment of a generated visualization slice taken along the slicing vector depicted in FIG. 6A.

FIG. 7A depicts an anatomical structure of a heart depicting a slicing vector.

FIG. 7B is an exemplary embodiment of a generated visualization slice taken along the slicing vector depicted in FIG. 7A.

FIG. 8 is a flow chart of an exemplary embodiment of a method of creating a slice image.

FIG. 9 is a flow chart that depicts an exemplary embodiment of a method of creating an animation of slice images.

FIG. 10 is a system diagram of an exemplary embodiment of a system for gesture based visualization of biomedical imaging or scientific data sets.

FIG. 11 is a state diagram that diagrammatically depicts the various states in an exemplary embodiment of a method of gesture control of data visualization

FIG. 12 is a system diagram of an exemplary embodiment of a system for data visualization.

### DETAILED DISCLOSURE

Visualization techniques as disclosed herein, exemplarily in the field of vascular biomechanics, enhance spatiotemporal understanding of multidimensional data sets, such as those covered generally by computational fluid dynamics (CFD) simulation. These simulations produce large amounts of data that must be compressed or manipulated to be visualized. A method of rapidly visualizing CFD results in an immersive visual environment (IVE) is disclosed herein. Embodiments therefore reduce the amount of compression or manipulation required for visualization. Within the IVE, and as further disclosed herein, custom controlled software interprets user gestures in an algorithm framework to deliver a hardware and software solution for visualization of medical imaging data in 3D stereoscopic images. These useful visualizations are achieved through integration of control software, video capture, and graphic displays. In embodiments, time-efficient generated data and an IVE can provide improved information and/or context to medical professionals. In non-limiting embodiments, such displays and data visualization may be used as treatment planning tools in pre-surgical, intra-surgical, and catheterization contexts.

Computational Fluid Dynamics (CFD) is a tool that can be used to study hemodynamic indices as using computer-based vascular representations. As such, CFD will be used as an exemplary embodiment of the biomedical or scientific data sets that may be visualized and manipulated through embodiments of the systems and methods as disclosed herein. This process generally involves creating a vascular model, discretizing the model into a mesh containing millions of elements, specifying rheological properties such as density and viscosity, prescribing the hemodynamic state at the entrance and exit of vessels (known as boundary conditions) and solving applicable governing equations with a powerful computer. Subsequent results such as wall shear stress (WSS), which is the frictional force experienced by a vessel tangentially due to flowing blood, and strain have been linked to the onset and progression of cardiovascular disease and can therefore be used to augment information obtained in a clinical setting. CFD produces time-varying data for the model's millions of elements during an entire cardiac cycle, but the traditional way of viewing this data has involved reducing multidimensional indices exerted on the walls of an artery to two-dimensions at a single time point and in a predetermined spatial configuration. In so doing, relationships between vessel features such as geometry, hemodynamic indices and atherosclerotic plaque morphology can be masked or not fully analyzed by medical professionals.

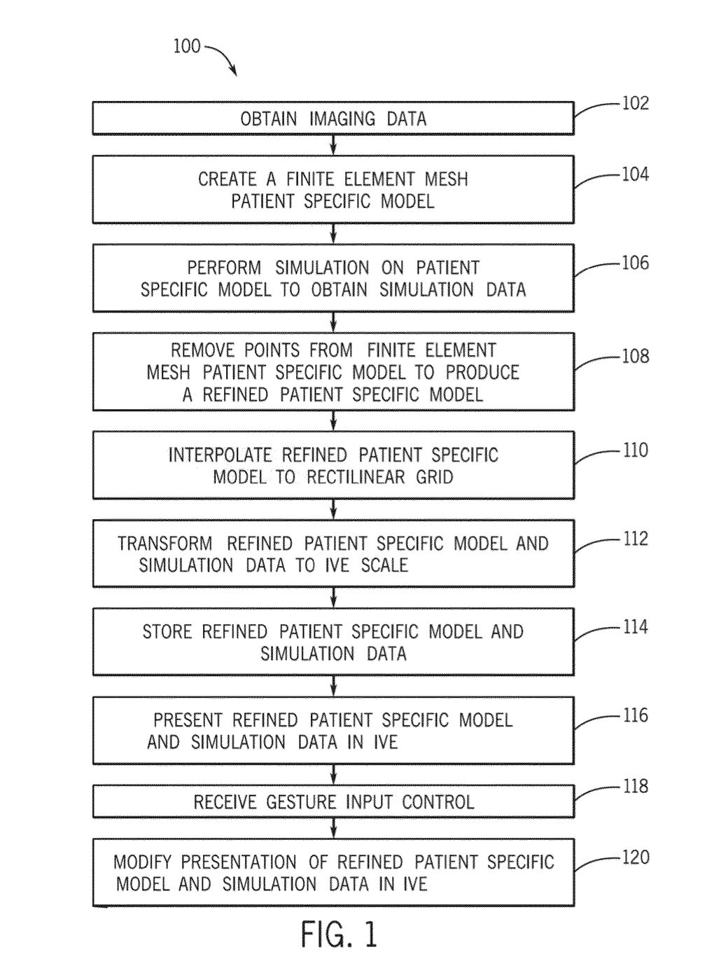

FIG. 1 is a flow chart that depicts a method 100 for rapidly visualizing medical imaging and simulation results. While a CFD simulation is exemplarily described, it will be recognized that other types of medical or scientific data sets may be similarly visualized. In exemplary embodiments, the data visualization can exemplarily be used for predicative treatment, planning, optimization and/or post-operative analysis.

The exemplary embodiment of the method 100 includes features to acquire medical imaging data, prepare and conduct CFD simulations and apply a series of post-processing steps to quickly produce scientific data visualization. It will be recognized that the method 100 is merely exemplary for the purposes of disclosure and that in alternative embodiments, steps may occur in varying orders or with more or fewer steps than depicted in FIG. 1, while remaining within the scope of the present disclosure. The exemplary embodiment of the method begins at 102 with the acquisition of 3D medical imaging data. The imaging data is segmented by a clinician or computer software, to identify important landmarks, which for a vessel may include the lumen and wall. In some models an intravascular stent may be virtually implanted to better emulate patient-specific flow conditions. At 104, a meshing algorithm is applied to the 3D model to discretize the volume into to a finite-element mesh patient specific model.

Next, a simulation is performed on the patient specific model at 106 in order to obtain simulation data. In embodiments, boundary conditions may be applied to the model prior to the simulation at 106. Inflow boundary conditions of the vessel can be determined using direct measurement from the patient by extrapolating from scientifically modeled generalizations. In a non-limiting embodiment inlet boundary conditions may be used from either normalized waveforms that have been scaled to the patient's body surface area, or a canine flow waveform that uses values for Reynolds and Womersley numbers that are reflective of human flow. In non-limiting embodiments, outlet flow boundary conditions are used from a three-element Windkessel model based on the blood pressure measured from the patient. The Windkessel model may exemplarily be used as a surrogate for the downstream impedance to blood flow and total arterial capacitance. The simulation at 106, exemplarily as a CFD simulation, is performed using a stabilized finite element solver with a commercial linear solver component LESLIB (exemplarily available from Altair Engineering, Troy, Mich.) to solve the time-dependent Navier-Stokes.

Once the simulation data is obtained at 106 the patient specific model and simulation data is further processed using a series of steps designed to prepare the data for use in an IVE. The processing of the patient specific model and simulation data for IVE presentation begins at 108 wherein points from the finite element mesh patient specific model are removed to produce a refined patient specific model. In an embodiment, the finite element mesh patient specific model is resampled to remove points not on a surface of the vessel by comparing the point locations to a connectivity matrix exemplarily provided by the software that produced the finite element mesh patient specific model at 140. Duplicate points are removed and the data is resampled and exemplarily stored in an unstructured grid format in three dimensions. A unit normal vector calculated for each element of the finite-element mesh exemplarily using visualization tool kit (VTK) functions. The normal vectors are used to interpolate a smooth vessel surface that improves the viewing experience. The Cartesian coordinates, normal vectors and neighbors of each node of the mesh are then stored as a connectivity matrix to produce the refined patient specific model at 108.

The refined patient specific model, which may be stored as a connectivity matrix as explained above, is used at 110 to interpolate the data onto a uniform rectilinear grid. In the uniform rectilinear grid, the spacing between each node is uniform in all directions. This interpolation to a rectilinear grid is required by embodiments of the visualization software to reduce memory requirements for displaying the data.

As noted above, a virtual intravascular stent is part of some CFD or other patient specific models. In such embodiments, the stent model is processed using the same steps described above but as a separate object from the patient specific model. The two models are combined in the VR software to allow the visualization properties of each to be controlled independently. Similarly, the same resampling procedures described above may be applied to the simulation data, which may exemplarily be hemodynamic data obtained from a CFD simulation, such that each point of simulation data directly maps to only one point on the refined patient specific model.

Next, at 112, the geometries of the refined patient specific model and, in some embodiments, the virtual stent model and/or the simulation data are rotated such that the direction of blood flow is parallel to a plane of the floor in the IVE. In an embodiment, this is accomplished using a standard rotation matrix, about the Y and Z axes and applies the rotation matrix to each node in the mesh of the refined patient specific model. When the rotation operation is complete, the patient specific model is oriented such that a line of sight of a user of the IVE is along a central axis of the patient specific model in the direction of blood flow. In embodiments, the angle of rotation is not fixed and may be uniquely calculated for each dataset.

Additionally, the refined patient specific model is scaled by a constant factor to maximize a field of view (FOV) when rendered in the IVE. In embodiments, the constant factor varies based on the original size and orientation of the refined patient specific model. Smaller or shorter refined patient specific models will undergo greater scaling than larger and/or longer patient specific models. In addition to scaling, the patient specific model is translated to fix a geometric center of the patient specific model at the origin of 3D space of the IVE. A general correction factor (η_{shift}) is calculated for each point in Cartesian space and applied as seen below:

η_{shift}=ηₘᵢₙ+δ (1)

The translation in the general correction factor is calculated from the spatial boundaries, ηₘₐₓ and ηₘᵢₙ:

$$δ = \frac{{η}_{max} - {η}_{min}}{2} \qquad ( 2 )$$

By fixing the point midway between the spatial boundaries to the origin, the refined patient specific model is centered at the desired location.

In further embodiments, manual orientation or location adjustment of the patient specific model is sometimes required for optimal results. Such adjustments may be described in terms of roll (counter-clockwise about the x-axis), pitch (y-axis) and yaw (z-axis). By applying these three transformations to the refined patient specific model, each experience in the IVE is controlled and represents the data in a consistent manner, which facilitates user familiarity and understanding from the outset of the visualization.

In some embodiments, a portion of the visualization content presented in the IVE is rendered directly from the simulation data, while other content is derived from the simulation data. In the exemplary embodiment of CFD, blood velocity may be visualized with time-varying vectors (arrows) indicating the direction of blood flow at each point in the cardiac cycle. These arrows may be distributed through the vessel's flow domain based upon a user or default input to determine the density of the arrows and proximity of the arrows to each other and the vessel lumen modeled by the refined patient specific model. In additional to the direction of blood flow being indicated by an angle of a particular vector's arrow, which is calculated for each frame, an arrow's length and/or color can denote a magnitude of blood flow velocity. In an embodiment, the color is determined through a lookup table whereby the scalar value of the velocity magnitude is linked to a Red/Green/Blue (RGB) color code.

In an embodiment, magnitude of the velocity vectors vary in magnitude relative to a maximum velocity in the cardiac cycle. The user is able to visualize the speed and direction of the blood at each point of the cardiac cycle using from these vectors. However, in order to effectively convey this information, the vectors must be distributed and spaced throughout the volume of the vessel in such a way that the flow information is not lost due to too many or too few vectors being present. In an embodiment, a vector distribution is determined by a function, based in part upon vessel diameter, to place seed points for these vectors at parameterized intervals throughout the lumen. The LCX coronary artery is a long, slender vessel with an average diameter of 2.85 mm whereas the average diameter of the distal common carotid artery ranges from 7.8 to 8.8 mm for women and men respectively. The exemplary carotid embodiment spaces vectors with an intra-vector distance of 1.5 mm, and the minimum distance between a vector and the wall is 0.5 mm. In an embodiment, placing the vectors near the wall enables visualization of no-slip conditions at the wall and also makes possible the visualization of areas of flow reversal as a direction of the velocity arrows may reverse, indicating retrograde flow. These exemplary embodiments may decrease the density of the vectors in the vessel and decrease the computational expense associated with rendering the vectors.

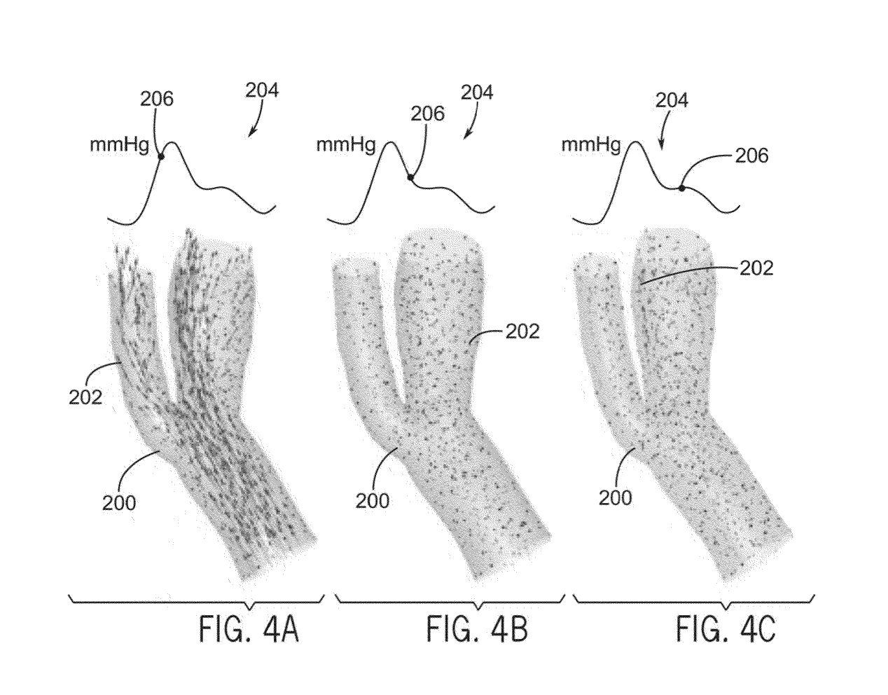

FIGS. 4A-4C exemplarily depict the visual presentation as described herein of the blood flow vectors 202 in a patient specific model 200 over time within a cardiac cycle. These visual presentations of FIGS. 4A-4C may be presented on a graphical display as a whole or a part of a graphical user interface presented on the graphical display. Velocity information from the CFD simulation is presented within the vessel where FIGS. 4A, 4B, and 4C each represent the vessel at various points in the cardiac cycle. The relative point in the cardiac cycle is denoted by the dot or indicator 206 on a pressure graph 204. From a comparison of FIGS. 4A-4C it will be noted that the longest (and therefore fastest velocity) vectors 202 are observed immediately before peak systole. Velocity magnitudes of the vectors 202 decrease as the cycle progresses. It is also to be noted from FIGS. 4A-4C that the near-wall velocities are markedly less than the velocities near the vessel centers.

An indication of the temporal position normalized to the cardiac cycle provides a fourth dimension to data analysis in the IVE. Continuing with the CFD example, blood pressure data is extracted from CFD simulation results to produce a plot of pressure versus time. Content displayed in an IVE is allowed to move in space as the user navigates about the data. In many applications, this IVE feature is desirable. However, in embodiments as presently disclosed herein, to communicate temporal data, a window with fixed spatial location and scale is needed to properly convey the point in time corresponding to the data being displayed. Therefore, a fixed viewing window is established in the IVE so that as the viewing angle of the data is changed, the pressure plot remains stationary and easy to read. The VR software maintains an internal chronometer that synchronizes events in time. A dot indicator is moved incrementally along the pressure plot at each time point in the cardiac cycle. This movement communicates the passage of time and relates the instantaneous hemodynamic indices (such as WSS) with other values like pressure and blood flow velocity that are displayed simultaneously.

In embodiments, the VR software (exemplarily EON studio available from EON Reality of Irvine, Calif.) manages all data with a hierarchical and modular structure. Once the data has been prepared with the methods described above, it is imported to the VR software in a manner that controls where and how the data is stored within the hierarchy to prepare the IVE. The hierarchy decreases rendering time and allows for a greater level of control in specifying what combinations of VR elements are realized. The VR software may use a file system that aggregates the necessary data for the simulation into a single resource file, making storage and transport of the VR content simple since only two files must be managed by the user (e.g. structure and simulation files).

The refined patient specific model geometry data file is read and converted to a 3D structure representing the model, which in the exemplary embodiment used herein is a vessel lumen. Similarly, if present, the stent geometry file is converted to a solid structure and combined with the refined patient specific model. Time-varying simulation data, which may be hemodynamic data, are treated as separate files for each point in time when imported to the IVE. The data contained in each file is then read, processed and rendered for each frame of the simulation. This process renders each file in rapid succession to produce the effect of moving objects in the IVE.

Referring back to the method 100 depicted in FIG. 1, the refined patient specific model and any simulation data is stored at 114 for later retrieval and presentation in the IVE. In addition, any additional visualization context derived from the simulation data as described above may be also stored at 114. In an exemplary embodiment, some or all of the data stored at 114 is stored in a hierarchical manner as described above.

At 116 the refined patient specific model and the simulation data is presented in an IVE. In an embodiment, the VR simulations and analyses are displayed in 3D with active stereoscopy. One frame of 3D simulation content is created from two projections of a single 3D object using unique points for the left and right eyes. The visualization file must be configured for projection in the IVE by programming the size and relative location of the one or more graphical displays used to present the IVE. In one exemplary embodiment, the IVE is presented on a single graphical display, exemplarily an LCD or LED display or other embodiments, may use tiled wall displays, projector displays, or audio-visual experience automatic virtual environments (CAVE). The visualization software manages the synchronization of the active shutter glasses and the alternating frames for the left and right eyes. In some embodiments, the refined patient specific model and simulation data can be used in treatment planning, exemplarily for surgical or catheterization procedures.

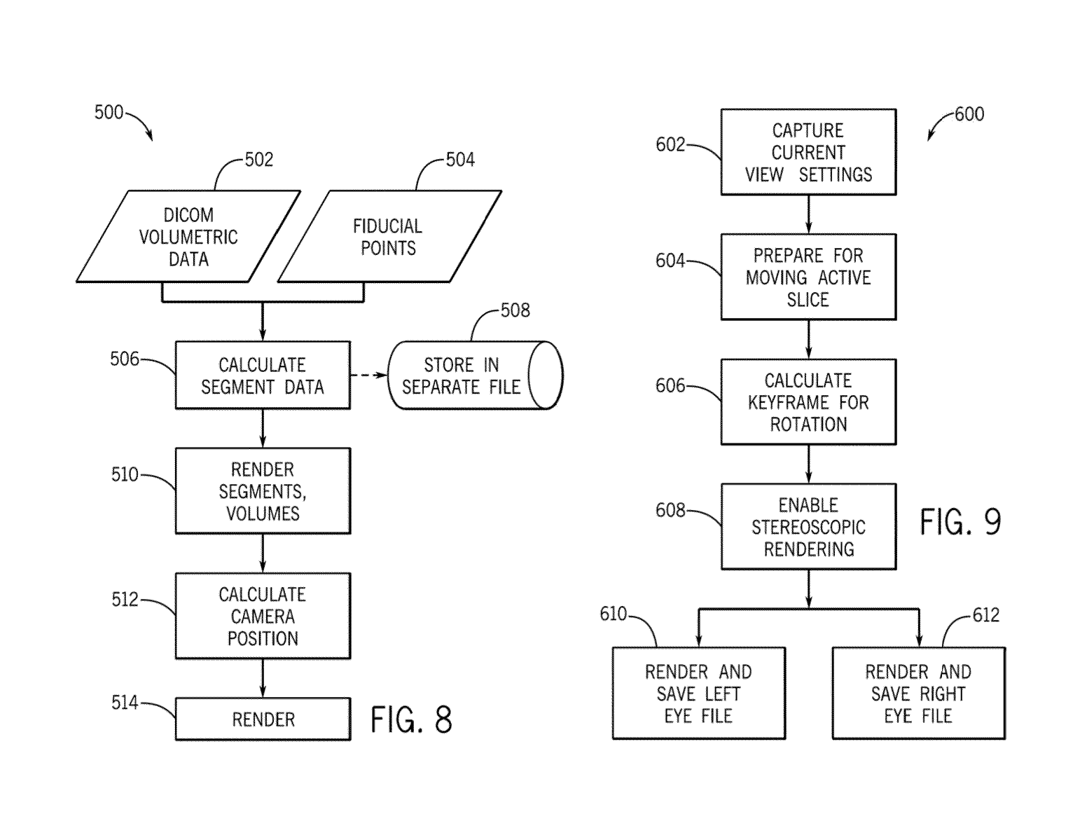

As will be described in further detail herein with respect to FIGS. 8-11, some embodiments of the method 100 further enable user gesture input control at 118 of the presented patient specific model and simulation data in the IVE. User gesture input controls received at 118 result in the modification of the presentation of the refined patient specific model and simulation data in the IVE at 120. This user gesture input control further facilitates clinician engagement and understanding of the biomedical and scientific datasets presented in the IVE by prompting clinician activity to move, manipulate, or modify the presented information to reveal views, structures, or perspectives that open up additional insight into the studied biomedical and scientific datasets.

In an additional embodiment of the methods as disclosed herein, one or more medical images from one or more imaging modalities are registered to the refined patient specific model. Image registration may exemplarily occur after the refined patient specific model is transformed at 112. It will be recognized that the image registration may occur in another order as well, exemplarily, but not limited to after interpolation of the refined patient specific model to the rectilinear grid at 110. A separate 3D plane is created in virtual space for each medical image that will be registered with the 3D vessel model. In an exemplary embodiment, the medical images may be MRI or CT images, but other forms of medical images may be used. These planes are added at a predetermined interval and do not necessarily represent the proper full size of the corresponding medical images. The planes are transformed using an algorithm specialized for the type of vessel being modeled and the imaging modality used to create a particular CFD model. In an embodiment, each plane is first translated to the origin of 3D space and then one or more rotations are specified by the imaging modality. These rotations can be unique for each medical image, or the same orientation can be applied to all the image data. The final step is to translate the planes back to an original location on the model, where each plane will have a proper orientation with respect to the refined patient specific model. The resulting rotated planes intersect the vessel model at locations and orientations that accurately reflect the relative positions of the anatomy and images at the time they were acquired. In an embodiment, each medical image is then applied to the plane in a way that an original aspect ratio of the medical image. This additional registered medical image data is then ready for rendering in 3D within an IVE.

FIG. 12 is a system diagram of an exemplary embodiment of a system 1200 which may be used to automatedly present visualizations of medical and scientific data sets in the manner as described herein. The system 1200 is generally a computing system that includes a processing system 1206, storage system 1204, software 1202, communication interface 1208, and a user interface 1210. The processing system 1206 loads and executes software 1202 from the storage system 1204, including a software module 1230. When executed by the computing system 1200, software module 1230 directs the processing system 1206 to operate as described herein, in further detail exemplarily in accordance with the method 100 and other embodiments as disclosed herein.

Although the computing system 1200 depicted in FIG. 12 includes one software module in the present example, it should be understood that one or more modules could provide the same operation. Similarly, while a description as provided herein refers to a computing system 1200 and a processing system 1206, it is to be recognized that implementations of such systems can be performed using one or more processors, which may be communicatively connected and such implementations are considered to be within the scope of the description.

The processing system 1206 can include a microprocessor and other circuitry that retrieves and executes software 1200 from storage system 1204. Processing system 1206 can be implanted within a single processing device, but can also be distributed across multiple processing devices or sub-systems that cooperate in executing program instructions. Examples of processing system 1206 include general purpose central processing units, application specific processors, and logic devices, as well as any other types of processing devices, combinations of processing devices, or variations thereof.

The storage system 1204 can include any storage media readable by a processing system 206, and capable of storing software 1202. The storage system 1204 can include volatile and non-volatile, removable and non-removable media implemented in any method of technology for storage of information, such as computer readable instructions, data structures, program modules, or other data. Storage system 1204 can be implemented as a single storage device but may also be implemented across multiple storage devices or sub-systems. Storage system 1204 can further include additional elements, such as a controller, capable of communicating with the processing system 1206.

Examples of storage media include random access memory read-only memory, magnetic discs, optical discs, flash memory discs, virtual and non-virtual memory, magnetic sets, magnetic tape, magnetic disc storage or other magnetic storage device, or any other medium which can be used to store the desired information and that may be accessed by an instruction execution system, as well as any combination or variation thereof or any other type of storage media. In some implementations, the storage media can be a non-transitory storage media.

User interface 1210 can include a mouse, a keyboard, a voice input device, a touch input device for receiving a gesture from a user, motion input device for detecting non-touch gestures and other motions by a user, and other comparable input devices and associated processing elements capable of receiving user input from a user. Output devices such as a video display or a graphical display and display an interface further associated with embodiments of the system and method as disclosed herein. Speakers, printers, haptic devices, and other types of output devices may also be included in the user interface 1210.

As described in further detail herein, the computing system 1200 receives imaging data 1240, simulation data 1250, and/or medical images 1220. The computing system 1200 executes the application modules stored therein to process the received data as disclosed herein in order to create and prepare the data visualizations as described in further detail. Exemplarily the computing system 1200 outputs a patient specific model 1260 and time dependent model data 1270 for combination and rendering. In other embodiments, the computing system 1200 combines and renders this data to produce the visualization which is presented on the user interface 1210. In still further embodiments, the user interface 1210 receives gesture inputs to modify or control the presented visualization.

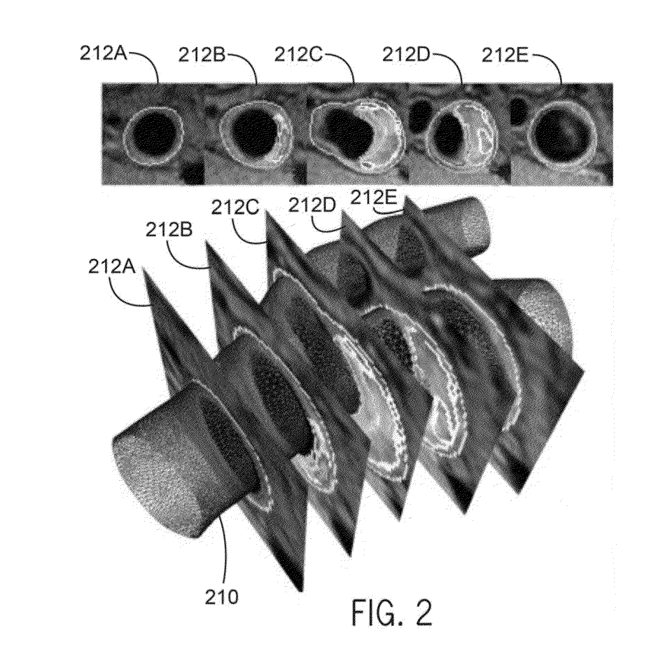

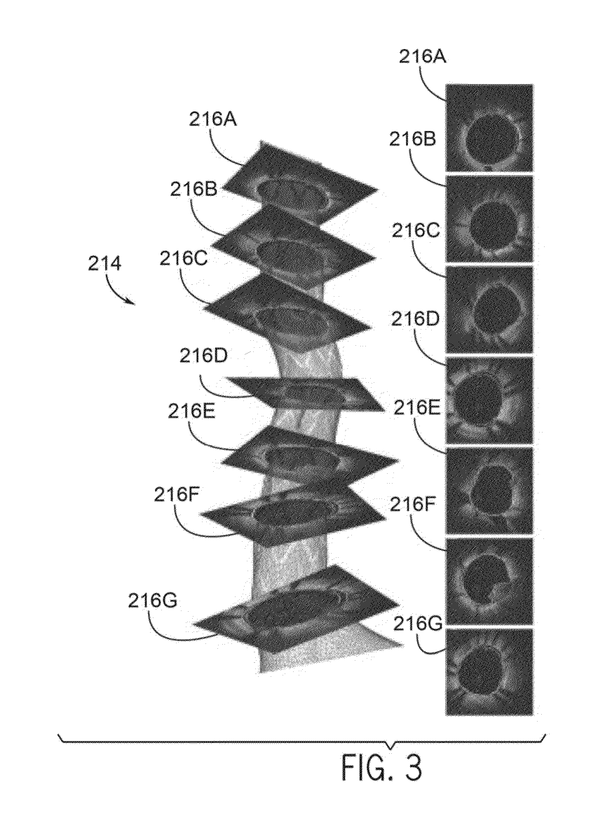

FIGS. 2 and 3 show exemplary embodiments of medical images (212A-E, 216A-G) registered to 3D patient specific model of vessels (210, 214) such as a result from the medical image registration described above, and which his described in further detail herein. In embodiments, the patient specific models 212, 214 are exemplarily refined patient specific models as described above. It should be noted that in FIG. 2, the medical images 212A-E, which are exemplarily MR images, are relatively evenly spaced and generally orthogonal to the direction of flow through the patient specific vessel model 210. Thus, a registration of the images 212A-E with the 3D patient specific model 210 in FIG. 2 may require less processing than registration of the images 216A-G with the 3D patient specific model 214 shown in FIG. 3. In FIG. 3, the medical images 216A-G are exemplarily optical coherent tomography (OCT) images and are less regularly spaced apart. In an embodiment, the OCT images 216A-G are acquired orthogonal to the plane of an imaging wire (not depicted) as the wire is retracted through the vessel within the patient. This produces images that are not necessarily orthogonal to the vessel's central axis and thus may require more intensive processing for image registration to the 3D patient specific model 214. In a still further aspect, and as best represented in FIG. 2, the 3D patient specific model 210 is constructed of a plurality of modeled anatomical structures that make up the vessel. In one embodiment, the images 212A-E and the 3D model 210 are color coordinated such that the same structures appear in the same color representations between the two merged data sets of the model and the registered medical images.

Looking to FIGS. 2 and 3 in greater detail, FIG. 2 depicts an exemplary embodiment of a medical image registration applied to carotid artery imaged with Magnetic Resonance (MR) imaging and FIG. 3 depicts an exemplary embodiment of medical image registration application to the LCX coronary artery as obtained with Optical Coherence Tomography (OCT) imaging. MR images are acquired in the anatomical transverse plane, such that they are aligned orthogonal to the vessel's central axis. For this reason, registration of MR images only requires the images to be spaced evenly to correspond to the MR slice thickness (e.g. 2 mm). In contrast, OCT imaging does not necessarily produce images orthogonal to the vessel's central axis, as is the case in MR. Therefore, in an embodiment, a most probable path taken by the imaging wire is first calculated, and this most probably path is used to calculate the rotations necessary to duplicate the image orientations as they were obtained in vivo. Equations [3] and [4] below exemplarily describe the angles calculated at the lower left corner ordered pair (x,y) of each image coordinate in the virtual space, where is z the depth dimension.

$$\begin{matrix}α = arctan ( \frac{x}{z} ) & ( 3 ) \\ β = arctan ( \frac{y}{x sin ( α ) + z cos ( α )} ) & ( 4 )\end{matrix}$$

Equations [5] and [6] show exemplary rotation matrices used to first rotate the image planes about the Y axis then the X axis. The combination produces the final orientations seen in FIG. 3.

$$\begin{matrix}{R}_{y} = [ \begin{matrix}cos α & 0 & - sin α \\ 0 & 1 & 0 \\ sin α & 0 & cos α\end{matrix} ] & ( 5 ) \\ {R}_{y} = [ \begin{matrix}1 & 0 & 0 \\ 0 & cos β & - sin β \\ 0 & sin β & cos β\end{matrix} ] & ( 6 )\end{matrix}$$

By way of example, the medical images of FIG. 2 may exemplarily depict the results obtained from a carotid artery investigation. In use or application, a user may be directed to observe the increased vessel wall thickness (where thickness is assumed to be the difference between the wall and lumen) visible in slices 212C and 212D along the external carotid artery, compared to the thickness in 212A. When viewed in an IVE, the wall thickness can be seen relative to the vessel length and diameter. This information can help the user build a 3D mental image of the carotid vasculature as it exists within the body. Such knowledge may be useful in clinical settings when planning procedures or analyzing results of medical imaging protocols.

In an embodiment, the visualization can include indication of Oscillatory Shear Index (OSI). OSI is an index of directional changes in WSS, where low OSI indicates the WSS is oriented predominantly in the direction of blood flow, while a value of 0.5 is indicative of bidirectional WSS with a time-average value of zero throughout the cardiac cycle. The velocity vectors presented in the 3D visualization make it possible to correlate regions of low or no flow with the vessel's structural features.

In embodiments, when the IVE renders an exemplary composite image as exemplarily shown in FIGS. 2 and 3 and which may also include time varying flow information, the user is able to observe the direct spatial relationship between the flow domain (indicated with the refined patient specific model), the medical imaging data and the vessel and plaque morphologies. These features relate to the structure of the imaged vessel (e.g. the carotid artery), but vessel function is visualized by rendering WSS and OSI on the vessel surface which enables the comparison of these values to the structural information obtained previously. When examined in the context of vessel geometry and the cardiac cycle, a user can begin to establish the spatiotemporal understanding between these exemplary features. For example, from a investigation of FIG. 2, a user may observe that regions of low time-averaged WSS have been shown to be preferential locations for the development of atherosclerotic regions as seen by the co-location of the fibrous cap/necrotic core with the low time-averaged WSS at slice 212C. The user can appreciate this by mapping the instantaneous or time-averaged WSS values to the vessel surface and rendering the segmented image slices. The visualization methods and systems disclosed herein therefore provide a new way to use and understand the data not previously available.

Referring to FIG. 3, the medical images presented in FIG. 3 are exemplarily from the LCX coronary artery. Rendering the OCT slices in an IVE allows spatial appreciation for the tortuous path through which the endoscopic imaging wire traveled during the OCT procedure. This is a surrogate for understanding the spatial dimensions and directions of the actual LCX coronary artery. By examining the model with the OCT slices shown, users can thus learn about the coronary circulation.

In an embodiment, a user may desire to investigate regions of low WSS which may create an environment favorable to the development of atherosclerosis. In an embodiment, this investigation is applied to in vivo patient data from at least two points in time to establish points of comparison needed to track disease progression. A comparative representation of the data as depicted in FIG. 3 between two imaging sessions (e.g. six months apart) enables conclusion to be drawn about parameters that change overtime. Such an embodiment can be extended to a plurality of locations and a plurality of times (e.g. imaging sessions), exemplarily throughout the course of a longitudinal clinical study or to track disease progression in a patient. Such an exemplary embodiment would enable visualization of changes in hemodynamic quantities in both time and space.

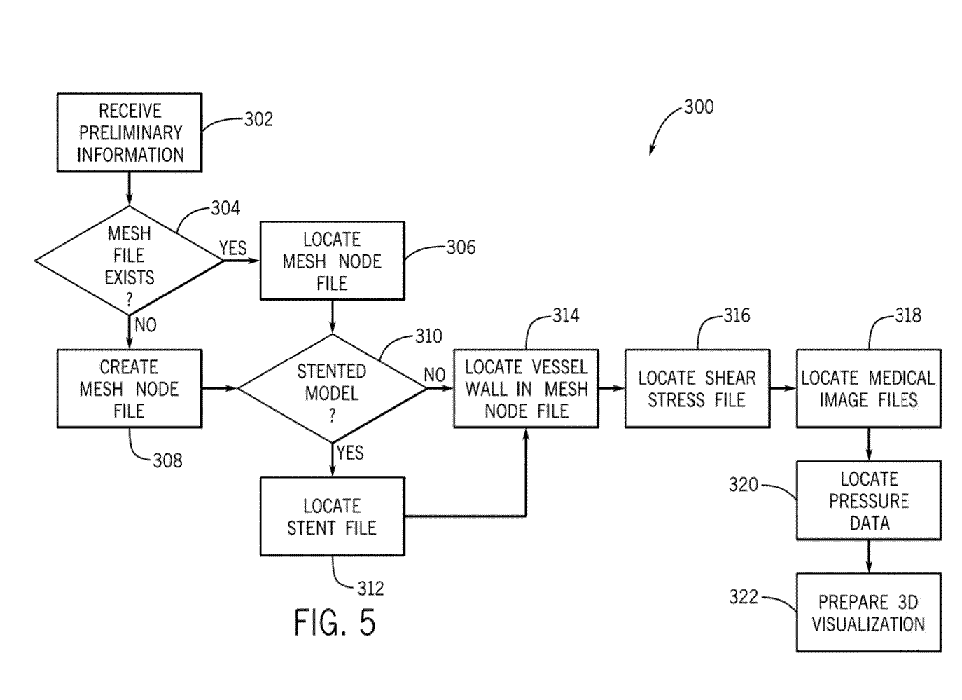

FIG. 5 is a flow chart that depicts an exemplary embodiment of post processing of image data for rapidly visualizing medical imaging and simulation results. In an exemplary embodiment, the method 300 may occur in conjunction with the method 100 as described above with respect to FIG. 1, exemplarily after the refined patient specific model and simulation data is transformed to the IVE scale at 112. In an exemplary embodiment, the method 300 functions to generate custom 3D content and prepare the IVE as described above. After preliminary information, such as the refined patient specific model, simulation data, and the transformation of this information to the IVE scale, is received at 302, the method 300 checks to determine if the mesh file exists at 304. The mesh file is a large file that contains mathematical x, y, z coordinates of a geometrical description of the refined patient specific model. If the mesh file has already been processed to place the data into nodes as described above, then the mesh node file may be located at 306 and used directly in the method. If the mesh node file has not yet been created and therefore identified as not existing at 304, then further processing is required to locate the mesh file and create the nodes and mesh node file from the mesh file at 308. In some embodiments, and some hemodynamic applications, either a planning of a stenting procedure or effectiveness of a stent is evaluated. At 310 a determination is made if the model is a stented model. If the model created is to be a stented model, then at 312 a 3D model of the stent is located within the refined patient specific model. This may be performed by accessing a library or other file of x, y, z geometric data of an actual stent to be used or modeled and adding this coordinate data to the 3D model.

At 314, a vessel wall is located from the mesh node file, which identifies x, y, z coordinates that are considered to be the wall of the refined patient specific model. As exemplarily depicted at 316, 318, and 320, data files of stored patient specific simulation data is located. This exemplarily includes locating wall shear stress data at 316, medical images to be registered to the model at 318, and pressure data at 320. These data files represent structural or functional data of the modeled vessel and which may be located within the 3D model. The vessel wall is represented in x, y, z Cartesian coordinates, while other files represent nodal values of for example wall shear stresses. Therefore, in exemplary embodiments, for every x, y, z coordinate of the vessel wall, there is a matching data point in a separate file that represents the amount of wall shear stress. Similar files can be created for other hemodynamic values, including, but not limited to, flow or blood pressure. Finally at 322, 3D visualization is prepared by combining the files to present both geometric structural data and quantitative functional data.

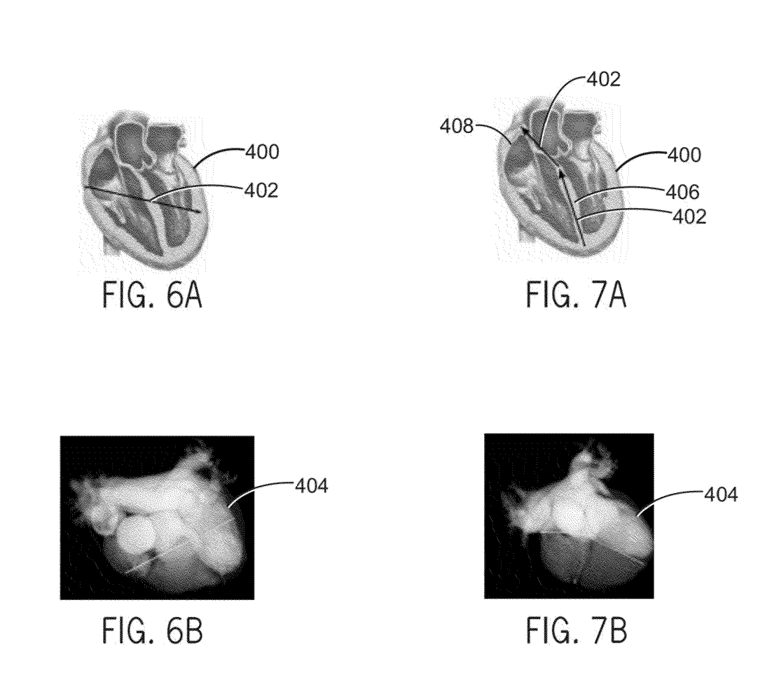

FIGS. 6A-7B depict still further embodiments of the visualization techniques as described herein. While the previous disclosed embodiment was disclosed with respect to an embodiment of presentation of vasculature, this embodiment is disclosed with respect to another anatomical structure, which in a non-limiting example is a pediatric heart, particularly for surgical planning or intra-surgical guidance. FIG. 8 is a flow chart that depicts an exemplary embodiment of a method 500 of creating a slice image. FIG. 9 is a flow chart that depicts an exemplary embodiment of a method 600 of creating an animation of slice images. In exemplary embodiment of both methods 500 and 600, the slice images are exemplarily a DICOM (Digital Imaging and Communications in Medicine) slice. The method 500 as described in further detail herein begins with two data sets and renders a visualization slice. The method 600 as described in further detail herein first captures current view settings and prepares two stereoscopic files for stereoscopic viewing. It will be recognized that embodiments of the methods 100 and 300 as disclosure herein may be similarly applied in the context of method 500 and 600 to visualize the embodiments depicted in FIGS. 6A-7B within an IVE.

Referring back to FIGS. 6A-7B, in general, the visualization technique disclosed herein creates a 3D model 400 of the anatomical structures (e.g. a pediatric heat) to be investigated. The 3D model 400 is exemplarily created from medical imaging data of the surgical patient. Then, rather than being limited to only those acquired medical images, a slicing vector 402 can be established through the 3D model and new visualization slices 404 taken of the 3D model along the slicing vector 402. With respect to the two exemplary embodiments depicted separately in 6A and 6B and 7A and 7B, a slice vector may be an approximation of the line of sight of the surgeon, such as in the orientation in which the organ presents itself during surgery as depicted in FIG. 6A. Alternatively, the slicing vector 402 may be defined to follow an anatomical structure, exemplarily the interventricular septum 406, as also shown in FIG. 7A. Particularly in a surgical planning application, these features can enable the surgeon to investigate and become familiar with specific anatomy of the patient's organs in this case, the heart prior to, or during, surgery. In a 3D stereoscopic presentation of the data along the slicing vector, the 3D modeled anatomical structure is sliced away perpendicular to the slicing vector such that the surface 2D rendered slice is presented, but also any 3D modeled structure visible beyond the 2D slice in the direction of the slicing vector.

In an exemplary embodiment of the method 500 DICOM volumetric data is acquired and prepared at 502. In an embodiment source datasets must first be cropped to the region of interest (ROI) exemplarily using a 3D sculpting tool. In typical cardiac images, cropping to an ROI involves manually removing the pulmonary vasculature, ribs and excess tissue information superior and inferior to the myocardium. However, not all anatomical structures are visible with all modalities. Therefore, the actual cropping will depend upon the modality of the source datasets. For example, bone is often not visible with MR images. In an embodiment, the system is set to parallel projection to avoid perspective errors. In an embodiment, the edited DICOM files are exported as a new set of discrete DICOM slices, retaining the original metadata. The cropped slices are then aggregated and converted to a volumetric dataset. In an embodiment, the DICOM volumetric data is saved in a uniform, rectilinear grid format that allows other software packages to process the data more efficiently.

At 504, fiducial landmark points are marked on the images in order to establish the slice vector (e.g. 402, FIGS. 6A, 7A) in the 3D volumes after the images have been processed. In an embodiment points are marked on a 2D image and software determines a depth location based on slice number of the 2D image. As described above, FIGS. 6A and 6B and FIGS. 7A and 7B disclose two embodiments for establishing 3D content. The first procedure (e.g. FIGS. 6A, 6B) establishes a slicing vector 402 along the line-of-sight (LOS) of the surgeon as if the surgeon were standing on the patient's right side. The LOS slicing vector 402 enters the myocardium on the anterolateral side of the right atrium and exits on the lateral wall of the left ventricle. Resampling the viewpoint vector along this slicing vector 402 allows the surgeon to preview the heart's anatomy prior to a procedure. The second procedure (e.g. FIGS. 7A, 7B) orients the DICOM images along two slicing vectors 402 that follow anatomical structures. The first slicing runs through the interventricular septum 406 to the center of the heart. The second slicing vector 402 bisects the atria through the interatrial septum 408.

Next at 506, segment data is calculated by processing the landmark points to calculate the length, direction and orientation (e.g. segment data) of the slicing vectors. This segment data is exemplarily stored at 508 and is used to resample the DICOM images at 510 to render segments and volumes of a 2D sampling of the 3D data at a specific location and orientation.

Once the slices have been calculated and rendered, visualizations are created. First camera positions are calculated at 512 and the new slice is rendered at 514. FIG. 9 depicts a flow chart of an additional method 600 for creating an animation of slice images. In the method 600, current view settings are captured at 602. In an exemplary embodiment, this includes accessing the slice images exemplarily created by application of the method 500. Next, at 604, a moving active slice is prepared. To provide detailed anatomic detail, the active slice is slowly translated along the slice vectors. Any combination of rotations, movements and transformations are possible as the active slice is translated, but in embodiments results are optimized for use as a pre-surgical planning tool. This optimization may involve a minimal amount of rotation calculated at 606 to allow the user to maintain spatial orientation relative to the heart.

In addition to the disclosed methods of preparation and processing of 3D content for visualization, an embodiment of a system for presentation and manipulation of 3D images, including the use of gestured-based controls, is also disclosed herein.

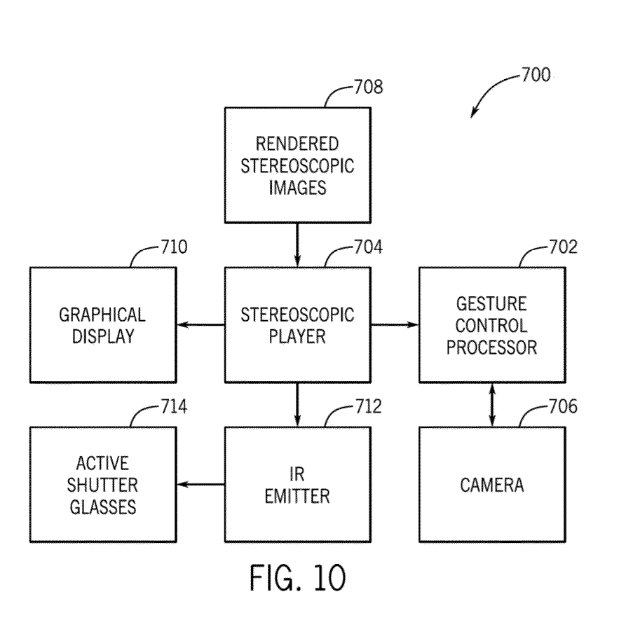

FIG. 10 is a system diagram of a system 700 for gesture-based visualization of biomedical imaging and scientific data sets. Software developed for this system and executed by a gesture control processor 702 and a stereoscopic player 704, as described in further detail herein, link a 3D depth sensing camera 706 and the controls of a stereoscopic video player 704 to detect hand gestures of a user to control the playback and data visualization functions of the 3D data presented by the system 700. In some embodiments, the 3D data presentation and gesture control is facilitated in real-time and includes the functionalities of rotating or scaling the 3D visualization data. Other gesture controls can apply transformation to the 3D visualization data, such as to alter the data view point or change model characteristics. Other embodiments may also include speech recognition or other user input controls.

The system 700 integrates the previously disclosed method with a stereoscopic display device. The system 700 generally includes a 3D depth sensing camera 706 that captures movements and gestures of the user as input controls. These are processed, interpreted, and carried out by a gesture control processor 702 which executes software stored on a non-transient computer readable medium, associated therewith to carry out the functions as described herein. A stereoscopic player 704, which may be implemented on the same processor or a different processor as the gesture control processor 702, receives the rendered stereoscopic images, exemplarily stored at a computer readable medium 708 and processes the images for stereoscopic presentation in accordance with the received user input controls. It is to be understood that in embodiments, the stereoscopic images may exemplarily be produced by the computing system 1200 as described above in accordance with one or more of the method disclosed herein. In the exemplary embodiment depicted in FIG. 10, the stereoscopic player 704 provides video data to a graphical display 710 and operates an IR emitter 712 to coordinately operate one or more pairs of active shutter glasses 714 so that the user alternatedly sees the right and left eye images to create the 3D visualization effect.

Some embodiments disclosed herein may present the visualization data on a computer screen, and may use active or passive stereoscopic viewing technology. In still other embodiments, the stereoscopic images produced by the video player are projected with a specialized projector onto a semi-transparent glass screen. The screen is coated with a polymer that rejects all light rays that do not strike within 180-35°. This filtering effect results in 3D images on the screen. These images are visible in stereo 3D from both sides of the screen for larger audiences to use the system and review visualization data as a group.

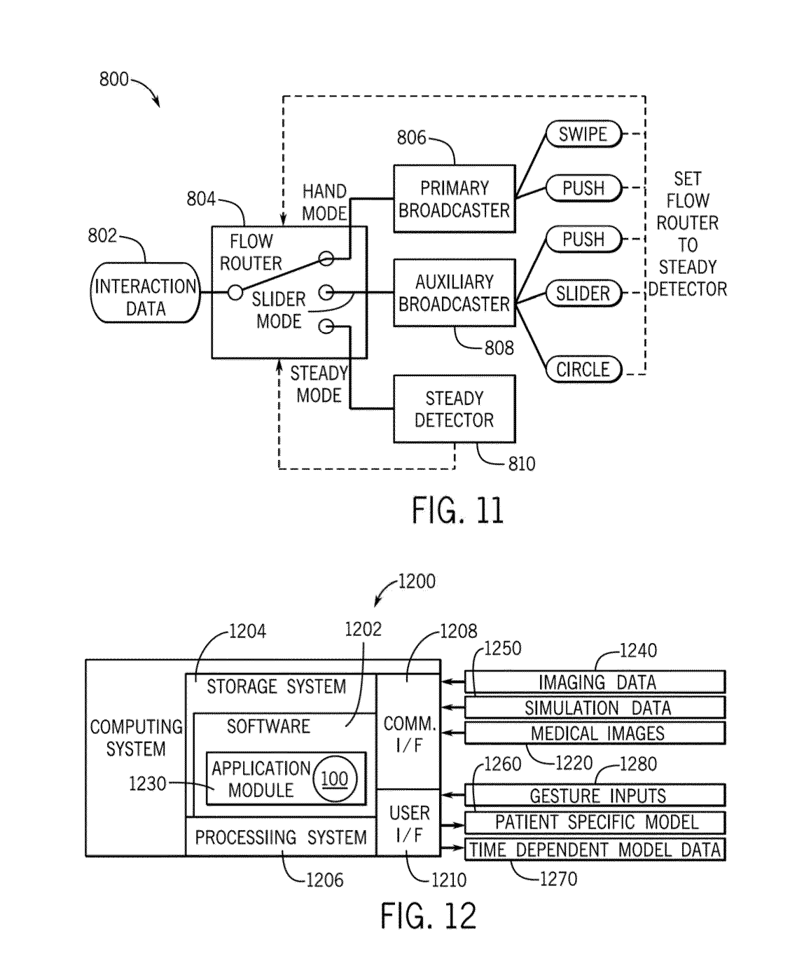

FIG. 11 is a state diagram that diagrammatically depicts the various states of a method 8 of gesture control of data visualization. In an embodiment, the method 800 is implemented by execution of a gesture identification and control algorithm exemplarily by the gesture control professor (FIG. 7). The flow chart depicted in FIG. 8 depicts one embodiment of how a gesture controlled platform with limited gesture detections, namely, swipe, push, slide, and circle gesture recognition can be leveraged to expand the number of controls available from those limited gestures. In an embodiment, a control gesture is used to toggle between two or more control states in which the same hand gestures can be interpreted as different input controls. For example, the state machine depicted in FIG. 8 operates in three different modes, namely hand mode, slider mode, and steady mode. A single hand gesture, exemplarily push gesture, may be used to toggle between any of the modes and then other hand gestures can be interpreted within that mode to enter the input desired by the user.

In an exemplary embodiment, interaction data 802 is acquired exemplarily from a three-dimensional camera. The interaction data 802 is provided to a flow router 804. The flow router may exemplarily operate to run the gesture detection and/or control algorithms with minimal impact on the performance of the rest of the application. Once a gesture event is detected in the interaction data 802, the gesture event is sent by the flow router 804 to the selected subroutine. In an exemplary embodiment, upon detection of a hand gesture, the method enters a primary broadcaster state 806, while upon detection of a slide gesture, the method enters a auxiliary broadcaster state 808. In an exemplary embodiment, the primary broadcaster state 806 interprets detected swipe and push gestures to control exemplarily soon and play/pause functions, while in the auxiliary broadcaster state 808 detected push, slide, or circle gestures control exemplarily image positioning, playback position, or exit functions. If no gesture is detected within a predetermined period the method enters a steady detector state 810. These subroutines call the low-level functions that ultimately carry out the desired command on the presented visualization data.

Swipe gestures used in an existing playback controls require the user to extend his hand beyond the normal bounds of the trunk. The natural follow-up movement after completing a swipe gesture will be to retract the hand back to its resting position.

Without correction, may gesture control will interpret this follow-up movement as a second swipe in the opposite direction. The method 800 operates in part, to prevent this. The state diagram 800 of FIG. 8 redirect the flow of camera data to specific algorithm. As described above, when the interaction data is received it is processed to trigger control events, e.g. hand mode, slide mode, and a steady mode. When no data is received, the method enters an idle state at the steads detector 810 and waits for new interaction data to arrive. In such an embodiment, the flow router 804 acts as the switch, directing the Interaction Data 802 to the proper broadcaster (e.g. primary broadcaster 806, auxiliary broadcaster 808, and steady detector 810), depending on a current state.

As disclosed above, the system operates in one of three states: Hand, Slider or Steady Mode. When in Hand Mode, interaction data 802 is directed to the Primary Broadcaster 806 by the flow router 804 and on to the gesture recognition algorithms connected to it. If the system is in Slider Mode, all interaction data 802 is sent to the auxiliary broadcaster 808 by the flow router 804 and none to the primary broadcaster 806. In an exemplary embodiment, after a gesture is recognized the system is put into steady mode. When in steady mode all interaction data 802 is sent to the steady detector 810 gesture recognition algorithm. The steady detector 810 is a type of gesture recognition algorithm that identifies when the hand is maintaining a relatively stationary position. The degree to which the hand must be held steady can be adjusted. When the hand is determined to have been steady for the specified period of time the data flow is returned to the flow router 804 and the nodes are again able to detect gestures.

The auxiliary broadcaster 808 allows the same gesture to have many different commands depending on the state of the system. When in Slider Mode, the Slider gesture recognition algorithm exemplarily calculates the horizontal position of the hand as a normalized distance from the origin. The normalized distance is then used to advance to the specified position in the video sequence. For example, if the user selects 0.75 using his hand and performs the push gesture, the Real-Time GUI will send a command to the stereoscopic player which begins playback at the time point 75% of the total time. The user can enter or leave Slider Mode with the Push gesture. When the system is in Hand Mode, the standard gestures of swipe, push, circle, slider bar, swipe right, swipe left, swipe up, and swipe down may be detected and the associated commands are sent to the Real-Time GUI.

In some embodiments, ability to tune the gesture recognition algorithms helps to maximize the number of environments in which the system is effective. Algorithms used to detect various hand motion gestures depend on the ability to detect motion of the hand. Due to the effect of a camera/hand distance, hand movement near the camera will appear to create a larger displacement than the same motion at the far end of the camera's POV.

In an exemplary embodiment, the systems and methods as disclosed herein find particular applicability and usefulness in treatment planning or evaluation applications. In embodiments, this may include planning of a stenting procedure, planning of another surgical procedure, optimization of such procedures before intervention, or post-procedure analysis and evaluation. The visualization solutions disclosed herein provide the added benefit of depth perception to create a realistic representation of medical datasets that can be manipulated intra-visualization (exemplarily by hand gestures). This visualization enables a user to investigate the models, simulations, and registered images in a manner that reveals data relationships that can be hidden, distorted, or obscured when presented in two dimensions or manipulated into other three dimensional presentations. Thus, the user is able to arrive at a better understanding of available medical datasets.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of three-dimensional visualization of biomedical datasets in an immersive visual environment (IVE), the method comprising:
obtaining imaging data;
creating a patient specific three-dimensional model from the imaging data, the patient specific three-dimensional model being a finite element mesh;
obtaining simulation data;
removing points from the finite element mesh, leaving only points on a surface of an imaged anatomical structure to produce a refined patient specific three-dimensional model;
interpolating the refined patient specific three-dimensional model and the simulation data onto a uniform rectilinear grid;
transforming the refined patient specific three-dimensional model and the simulation data to a scale of the IVE; and
presenting the refined patient specific three-dimensional model and the simulation data within the IVE with a three-dimensional visualization system.

2. The method of claim 1, further comprising:
calculating a unit normal vector for each element of the finite element mesh; and
interpolating a smooth surface for the refined patient specific three-dimensional model.

3. The method of claim 1, further comprising:
calculating a correction factor based upon the spatial boundaries of the patient specific three-dimensional model; and
translating the patient specific three-dimensional model according to the correction factor to center the patient specific three-dimensional model in the IVE.

4. The method of claim 1, wherein the refined patient specific three-dimensional model is further produced by:
comparing a location of each of a plurality of points in the finite element mesh to a connectivity matrix;
removing duplicate points from the comparison; and
resampling the finite element mesh of the patient specific three-dimensional model.

5. The method of claim 1, further comprising:
creating a stent three-dimensional model of a stent associated with the imaged anatomical structure, wherein the stent three-dimensional model is a finite element mesh;
removing points from the finite element mesh of the stent three-dimensional model to produce a refined stent three-dimensional model;
combining the refined stent three-dimensional model into the refined patient specific three-dimensional model.

6. The method of claim 1, further comprising storing the refined patient specific three-dimensional model and the simulation data into a hierarchical structure, wherein the simulation data is stored as a separate file for each point in time.

7. The method of claim 1 wherein obtaining the simulation data comprises performing a simulation on the patient specific three-dimensional model to obtain time varying simulation data.

8. The method of claim 7, further comprising:
generating additional three-dimensional content from the simulation data; and
adding the additional three-dimensional content to the three-dimensional model.

9. The method of claim 7, wherein the simulation data is hemodynamic simulation data normalized to a cardiac cycle.

10. The method of claim 9, wherein the simulation performed on the patient specific three-dimensional model is a computational fluid dynamics (CFD) simulation.

11. The method of claim 1, further comprising:
creating a three-dimensional plane for each of a plurality of stored medical images at predetermined intervals;
translating each of the three-dimensional planes to the origin of the IVE based upon the imaging modality used to acquire the plurality of stored medical images and the anatomical structure imaged; and
translating each of the three-dimensional planes to the three-dimensional model to register the stored medical images to the three-dimensional model.

12. The method of claim 1, further comprising segmenting the imaging data to identify vessel landmarks.

13. The method of claim 1, further comprising implanting a stent into the patient specific three-dimensional model.

14. The method of claim 1, further comprising:
determining a direction of flow within the refined patient specific three-dimensional model; and
rotating the refined patient specific three-dimensional model such that the direction of flow is parallel to a flow of the IVE.

15. The method of claim 1, wherein the imaged anatomical structure is a vessel.

16. The method of claim 1, further comprising:
providing a hierarchy of gesture input states wherein a first gesture input selects a control mode and one or more subsequent gesture inputs operational commands;
receiving a first gesture input;
selecting the control mode;
receiving a subsequent gesture input; and
interpreting the subsequent gesture input as an operational command.

17. The method of claim 16, wherein the control mode is selected from between a visualization command mode and a file navigation mode.

18. The method of claim 1, further comprising:
calculating a current view of the refined patient specific three-dimensional model;
calculating a visualization path through the refined patient specific three-dimensional model;
calculating key frames for view rotation to follow visualization path minimizing view rotation;
rendering a series of three-dimensional views of the refined patient specific three-dimensional model along the visualization path; and
sequentially presenting the series of three-dimensional views.

19. A method of three-dimensional visualization of biomedical datasets in an immersive visualization environment (IVE), the method comprising:
obtaining imaging data;
creating a patient specific three-dimensional model from the imaging data, the patient specific three-dimensional model being a finite element mesh;
performing a simulation on the patient specific three-dimensional model to obtain simulation data;
removing points from the finite element mesh, leaving only points on a surface of an imaged anatomical structure to produce a refined patient specific three-dimensional model;
interpolating the refined patient specific three-dimensional model and the simulation data onto a uniform rectilinear grid;
transforming the refined patient specific three-dimensional model and the simulation data to a scale of the IVE;
determining a direction of flow within the refined patient specific three-dimensional model;
rotating the refined patient specific three-dimensional model such that the direction of flow is parallel to a floor of the IVE;
creating a three-dimensional plane for each of a plurality of stored medical images;
translating each of the three-dimensional planes to the origin of the IVE based upon an imaging modality used to acquire the plurality of stored medical images and the anatomical structure imaged;
translating each of the three-dimensional planes to the three-dimensional model to register the stored medical images to the three-dimensional model; and
presenting the refined patient specific three-dimensional model, the simulation data, and the registered medical images, within the IVE with a three-dimensional visualization system.

20. A system for visualization of biomedical datasets in an immersive visualization environment (IVE), the system comprising:
a computing system comprising a processor and a computer readable medium programmed with computer readable code that upon execution by the processor:
obtains imaging data;
creates a patient specific three-dimensional model from the imaging data, the patient specific three-dimensional model being a finite element mesh;
performs a simulation on the patient specific three-dimensional model to obtain simulation data;
removes points from the finite element mesh, leaving only points on a surface of an imaged anatomical structure to produce a refined patient specific three-dimensional model;
interpolates the refined patient specific three-dimensional model and the simulation data onto a uniform rectilinear grid; and
transforms the refined patient specific three-dimensional model and the simulation data to a scale of the IVE;
a graphical display operated by the computing system to create the IVE and present the refined patient specific three-dimensional model and the simulation data within the IVE; and
a user input device capable of acquiring a user gesture input, the computing system identifies an acquired user gesture input and modifies the presented refined patient specific three-dimensional model and the simulation data within the IVE in accordance with the gesture input.
